(19) United States
(12) Patent Application Publication
(10) Pub. No.: US 2026/0269936 A1
(43) Pub. Date: Sep. 10, 2026

(54) METHODS AND APPARATUS FOR SATELLITE SWITCHING IN MOBILE COMMUNICATIONS

(71) Applicant: MediaTek Singapore Pte. Ltd., Singapore (SG)

(72) Inventors: Wen TANG, Beijing (CN); Chun-Chia CHEN, Hsinchu City (TW)

(21) Appl. No.: 19/165,994

(22) PCT Filed: May 16, 2024
(86) PCT No.: PCT/CN2024/093553

§ 371 Date: Sep. 16, 2025

(30) Foreign Application Priority Data
May 16, 2023 (WO) PCT/CN2023/094553

(51) Int. Cl. H04B 7/185; H04L 1/1812; H04W 56/00; H04W 76/20; H04W 80/02

(52) U.S. Cl. CPC H04B 7/18541; H04B 7/1855; H04L 1/1812; H04W 56/0045; H04W 76/20; H04W 80/02

(57) ABSTRACT

Various solutions for satellite switching in mobile communications are described. An apparatus may connect to a first satellite of a wireless network to operate in a connected state. Then, the apparatus may receive a command or condition information for triggering a satellite switching from the first satellite. The apparatus may further switch from the first satellite to the second satellite based on the command or the condition information.

### CROSS REFERENCE TO RELATED PATENT APPLICATION(S)

The present disclosure is part of a non-provisional application claiming the priority benefit of PCT Application No. PCT/CN2023/094553, filed 16 May 2023, the content of which herein being incorporated by reference in its entirety.

### TECHNICAL FIELD

The present disclosure is generally related to mobile communications and, more particularly, to satellite switching with respect to user equipment (UE) and network apparatus (e.g., satellite) in mobile communications.

### BACKGROUND

Unless otherwise indicated herein, approaches described in this section are not prior art to the claims listed below and are not admitted as prior art by inclusion in this section.

In 3^{rd} Generation Partnership Project (3GPP) Release 17, NTN is introduced as a terminal-satellite direct communication technology based on the new radio (NR) interface. With the integration of satellite network and ground cellular network (e.g., 5^{th} generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) UEs. NR NTN uses the 5G NR framework to enable direct connection between satellites and smartphones to provide voice and data services.

In an NTN, due to the satellite is moving, a UE may need to perform satellite switching, so as to ensure normal transmission during a long connection time and to avoid radio link failure. However, in current 3GPP Release 18 standards, detailed operations related to satellite switching have not been fully discussed and defined. Therefore, there is a need to provide proper schemes and designs for procedures allowing the UE and the network to perform satellite switching in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes and designs for procedures allowing the UE and the network to perform satellite switching in mobile communications.

In one aspect, a method may involve an apparatus connecting to a first satellite of a wireless network to operate in a connected state. The method may also involve the apparatus receiving a command or condition information for triggering a satellite switching from the first satellite. The method may further involve the apparatus switching from the first satellite to the second satellite based on the command or the condition information.

In one aspect, an apparatus may comprise a transceiver which, during operation, wirelessly communicates with a first satellite or a second satellite of a wireless network. The apparatus may also comprise a processor communicatively coupled to the transceiver. The processor, during operation, may perform operations comprising connecting, via the transceiver, to the first satellite to operate in a connected state. The processor may also perform operations comprising receiving a command or condition information for triggering a satellite switching from the first satellite. The processor may further perform operations comprising switching from the first satellite to the second satellite based on the command or the condition information.

In one aspect, a method may involve a first satellite connecting with an apparatus for the apparatus to operate in a connected state. The method may also involve the first satellite transmitting a command or condition information to the apparatus for triggering the apparatus to switch from the first satellite to a second satellite.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B 5 G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of hard satellite switching in accordance with the present disclosure.

FIG. 2 is a diagram depicting an example scenario of soft satellite switching in accordance with the present disclosure.

FIG. 3 is a diagram depicting an example scenario of a communication environment in which various solutions and schemes in accordance with the present disclosure may be implemented.

FIG. 4 is a diagram depicting an example scenario of satellite switching in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to satellite switching in mobile communications. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on. It is noteworthy that the present disclosure is motivated by, but not limited to, an NTN scenario.

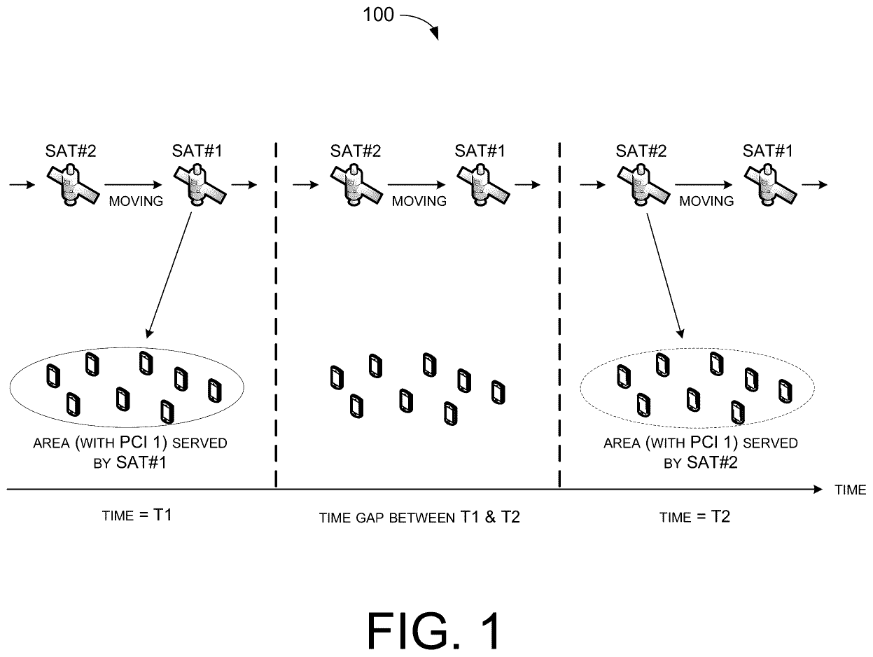

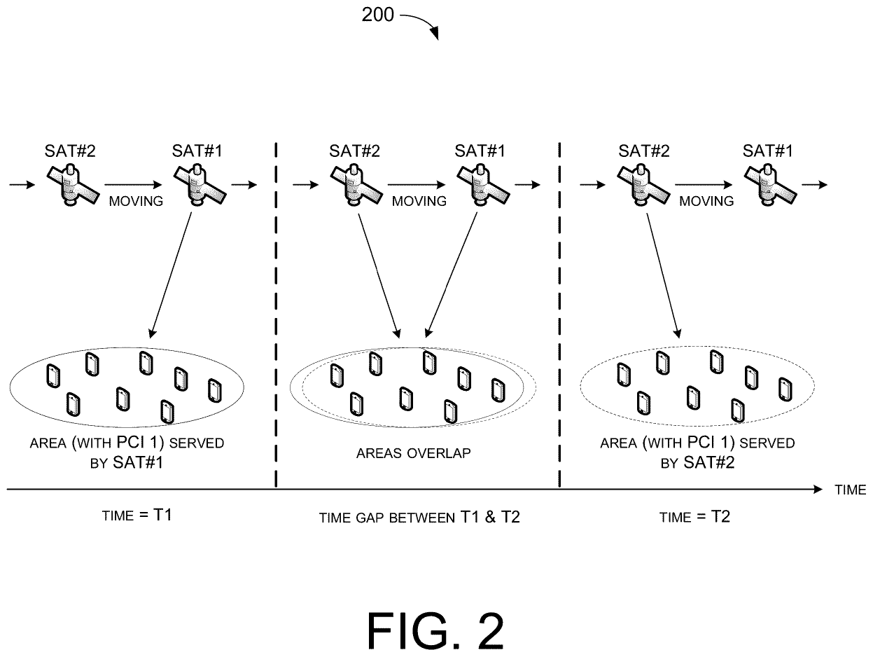

In 3GPP Release 18, for mobility enhancement, the unchanged physical cell identifier (PCI) scenario, including hard satellite switching (non-overlapping satellite coverage at switching time) and soft satellite switching (overlapping satellite coverage at switching time), are discussed for the use case of quasi-earth fixed cell. FIG. 1 illustrates an example scenario 100 of hard satellite switching in accordance with the present disclosure. As shown in FIG. 1, a plurality of UEs are in an area covered by satellite 1 (denoted as SAT #1) at time T1 and covered by satellite 2 (denoted as SAT #2) at time T2, but in the time gap between time T1 and time T2, the area is not covered by either satellite 1 or satellite 2. As such, the UEs in the area may experience a temporary connection unavailability during the satellite switching. FIG. 2 illustrates an example scenario 200 of soft satellite switching in accordance with the present disclosure. Scenario 200 is similar to scenario 100, except that in the time gap between time T1 and time T2, the area is covered by both satellite 1 and satellite 2, such that connection remains available during the satellite switching.

It is agreed in 3GPP radio access network (RAN) working group (WG) 2 (or called RAN2) that, in the case of quasi-earth fixed cell, satellite switching without PCI changing (not requiring layer-3 (L3) mobility) is supported for hard satellite switching in the same synchronization signal block (SSB) frequency and the same Next Generation Node-B (gNB). However, in current 3GPP Release 18 standards, detailed operations related to satellite switching have not been fully discussed and defined.

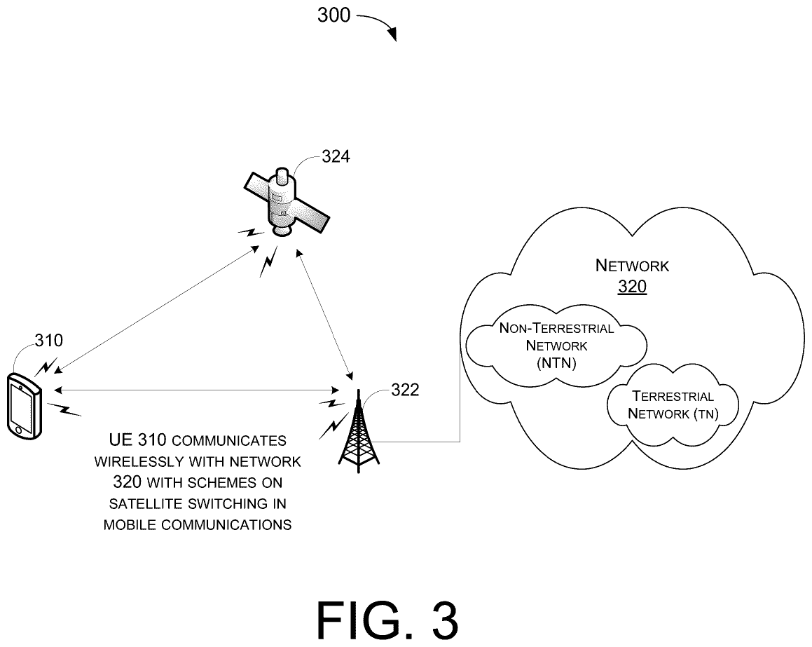

In view of the above, the present disclosure proposes a number of schemes pertaining to satellite switching with or without PCI changing for 5G NR, B 5G, or 6G. FIG. 3 illustrates an example scenario 300 of a communication environment in which various solutions and schemes in accordance with the present disclosure may be implemented. Scenario 300 involves a UE 310 in wireless communication with a network 320 (e.g., a wireless network including an NTN and a TN) via a terrestrial network node 322 (e.g., a base station (BS) such as an evolved Node-B (eNB), a gNB, or a transmission/reception point (TRP)) and/or a non-terrestrial network node 324 (e.g., satellite(s)). In some implementations, the terrestrial network node 322 and the non-terrestrial network node 324 may form an NTN serving cell for wireless communication with the UE 310. Alternatively, the non-terrestrial network node 324 may have built-in BS functionalities to form an NTN serving cell for wireless communication with the UE 310, without involving any BS. In such communication environment, the UE 310, the network 320, and either one of both of the terrestrial network node 322 and the non-terrestrial network node 324 may implement various schemes pertaining to satellite switching in mobile communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under a first proposed scheme of the present disclosure, a UE may connect to a first satellite of a wireless network to operate in a connected state (e.g., RRC_CONNECTED mode). Then, the UE may receive a command or condition information for triggering a satellite switching from the first satellite. After that, the UE may switch from the first satellite to a second satellite of the wireless network based on the command or the condition information. Accordingly, by applying the first proposed scheme of the present disclosure, the UE and the network are allowed to perform satellite switching to ensure normal operation in an NTN and avoid radio link failure.

In some implementations, the triggering of the satellite switching may be RRC-based or MAC CE-based. For example, the command may include an RRC signaling or a medium access control (MAC) control element (CE). That is, a new RRC signaling may be used to trigger satellite switching with or without PCI changing (i.e., the PCI of the (NTN) cell serving the UE may be changed or unchanged after the satellite switching). Alternatively, a new MAC CE may be used to trigger satellite switching with or without PCI changing.

In some implementations, the triggering of the satellite switching may be time-based. For example, the condition information may be received via an RRC signaling, a MAC CE, or a SIB, and may include new time duration parameter(s) or reuse existing time duration parameter(s), and the satellite switching is triggered when the UE's time is in the time duration. In one example, the condition information may include first time information (e.g., the ‘t-Service’ field in a system information block (SIB) such as SIB type 19 (SIB19)) on when the first satellite is going to stop serving an area that the first satellite is currently covering, and second time information (e.g., the ‘t-ServiceStart’ field in a SIB such as SIB19) on when the second satellite is going to start serving the area. The UE may perform the satellite switching between the time indicated by the first time information and the time indicated by the second time information.

In some implementations, the triggering of the satellite switching may be location-based. For example, the condition information may be received via an RRC signaling, a MAC CE, or a SIB, and may include new location (related) information or reuse existing location (related) information on where the UE is to be triggered for the satellite switching.

In some implementations, the triggering of the satellite switching may be UE-autonomous. For example, the condition information may be received via an RRC signaling, a MAC CE, or a SIB, and may include a value of a (new) timer configured by the network to indicate when to trigger the satellite switching. That is, the UE may perform the satellite switching when the timer expires.

Under a second proposed scheme of the present disclosure, the UE may receive a satellite switching configuration from the first satellite, i.e., configuration signaling for satellite switching with or without PCI changing is provided. Accordingly, by applying the second proposed scheme of the present disclosure, the satellite switching may be performed based on the satellite switching configuration.

In some implementations, the satellite switching configuration may include a UE-specific configuration, and may be received via an RRC signaling or a MAC CE.

In some implementations, the satellite switching configuration may include a common configuration (i.e., a configuration common to all UEs), and may be received via an SIB (e.g., a new SIB or an existing SIB such as SIB19 with new parameter).

In some implementations, the satellite switching configuration may include a group UE (e.g., a group of UEs in the same serving area/cell) configuration, and may be received via an RRC signaling.

Under a third proposed scheme of the present disclosure, detailed contents of the satellite switching configuration (e.g., a common configuration) are provided, including at least one of the following: (i) ephemeris information (e.g., neighbor satellite's space service volume (SSV) information consisting of position, velocity and time (PVT) and orbital parameters) of the target satellite (e.g., the second satellite); (ii) common timing advance (TA) information of the target satellite (e.g., the second satellite), which indicates the TA between the target satellite and the reference point (RP); (iii) the scheduling offset K_{offset} for allowing the UE sufficient processing time between a downlink (DL) reception and an uplink (UL) transmission with the target satellite (e.g., the second satellite); (iv) the offset K_{mac} for delaying an application of a DL configuration indicated by a MAC CE command on a physical downlink shared channel (PDSCH) from the target satellite (e.g., the second satellite); and (v) a configuration for an UL hybrid automatic repeat request (HARQ) after the satellite switching.

In some implementations, the configuration for the UL HARQ after the satellite switching may include a frequency hopping flag, a PUSCH frequency resource allocation, a modulation and coding scheme (MCS), a transmit power control (TPC) command for physical uplink shared channel (PUSCH), a channel state information (CSI) request, and a new K_s to indicate the PDSCH-to-PUSCH timing indicator or indicate additional timing offset for K_2, etc.

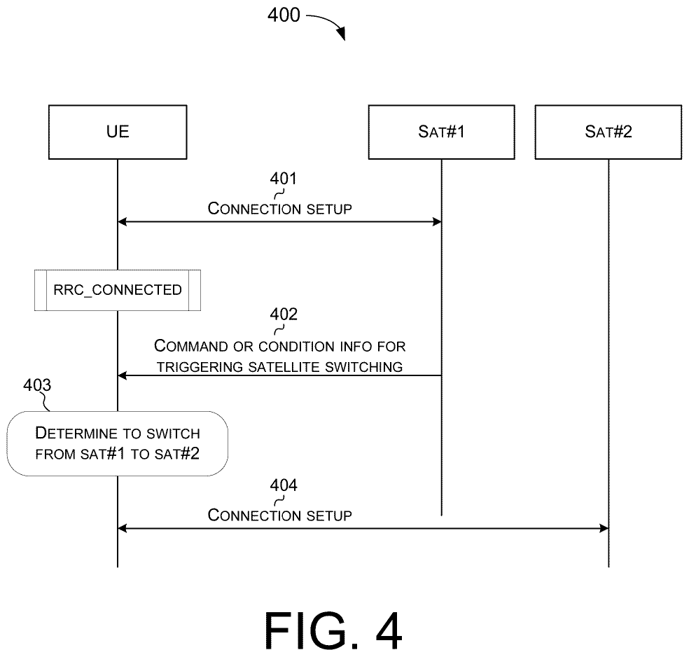

FIG. 4 illustrates an example scenario 400 of satellite switching in accordance with an implementation of the present disclosure. At 401, the UE connects to the first satellite (denoted as SAT #1), and enters RRC_CONNECTED mode. At 402, the UE receives a command or condition information for triggering a satellite switching from the first satellite. As described above, the command may include an RRC signaling or a MAC CE for the triggering, while the condition information may include time information, location information, or a value of a timer for the triggering. At 403, the UE determines to perform satellite switching by switching from the first satellite to the second satellite. At 404, the UE connects to the second satellite (denoted as SAT #2) to complete the switching. Depending on the network deployment, the connection between the UE and the first/second satellite may be set up with or without involving a BS (e.g., a gNB). If each of the first satellite and the second satellite has complete BS functionalities (i.e., the first/second satellite can communicate with the UE directly without involving a ground BS), then the PCI of the cell (formed by the first satellite) serving the UE before the satellite switching will be different from the PCI of the cell (formed by the second satellite) serving the UE after the satellite switching, i.e., the aforementioned satellite switching with PCI changing). Alternatively, if each of the first satellite and the second satellite does not have complete BS functionalities (i.e., the first/second satellite relies on a ground BS to communicate with the UE), then the cell (formed by the ground BS) serving the UE and the cell's PCI before and after the satellite switching will remain the same, i.e., the aforementioned satellite switching without PCI changing.

### Illustrative Implementations

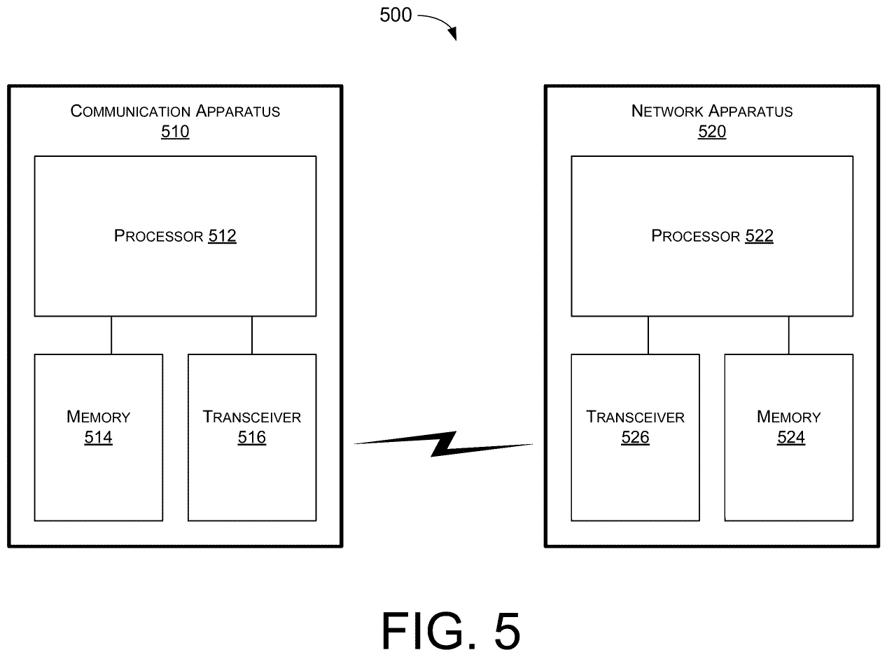

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to satellite switching in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 510 may also be a part of a machine type apparatus, which may be an IoT, NB-IoT, IIoT, bandwidth reduced low complexity (BL), or coverage enhancement (CE) UE such as an immobile or a stationary apparatus, a home apparatus, a roadside unit (RSU), a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a satellite, a BS, a small cell, a router or a gateway of an NTN. For instance, network apparatus 520 may be implemented in a satellite and/or an eNB/gNB/TRP in a 4G/5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks, including satellite switching in mobile communications, in a device (e.g., as represented by communication apparatus 510) and a network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as a UE, and network apparatus 520, as a network node (e.g., satellite), is provided below.

Under certain proposed schemes in accordance with the present disclosure with respect to satellite switching from UE's perspective, processor 512 of communication apparatus 510 may connect, via transceiver 516, to a first satellite to operate in a connected state (e.g., RRC_CONNECTED mode). Then, processor 512 may receive, via transceiver 516, a command or condition information for triggering a satellite switching from the first satellite. Also, processor 512 may switch, via transceiver 516, from the first satellite to a second satellite based on the command or the condition information. On the other hand, from network's perspective, processor 522 of network apparatus 520 (e.g., a first satellite) may connect, via transceiver 526, with communication apparatus 510 for communication apparatus 510 to operate in a connected state (e.g., RRC_CONNECTED mode). Then, processor 522 may transmit, via transceiver 526, a command or condition information to communication apparatus 510 for triggering communication apparatus 510 to switch from the first satellite to a second satellite.

In some implementations, the command or the condition information may be received via an RRC signaling, a MAC CE, or a SIB.

In some implementations, the condition information may include at least one of the following: (i) first time information on when the first satellite is going to stop serving an area that the first satellite is currently covering, and second time information on when the second satellite is going to start serving the area; (ii) location information on where the apparatus is to be triggered for the satellite switching; and (iii) a value of a timer, wherein the switching from the first satellite to the second satellite is performed in an event that the timer expires.

In some implementations, the switching from the first satellite to the second satellite may be performed between a first time indicated by the first time information and a second time indicated by the second time information.

In some implementations, processor 512 may also receive, via transceiver 516, a satellite switching configuration from the first satellite, wherein the switching from the first satellite to the second satellite is performed based on the satellite switching configuration.

In some implementations, the satellite switching configuration may be received via an RRC signaling, a MAC CE, or a SIB, and include a UE-specific configuration, a common configuration, or a group UE configuration.

In some implementations, the common configuration may include at least one of the following: (i) ephemeris information (e.g., neighbor satellite's SSV information consisting of PVT and orbital parameters) of the second satellite; (ii) common TA information of the second satellite, which indicates the TA between the second satellite and the RP; (iii) the scheduling offset K_{offset} for allowing the UE sufficient processing time between a DL reception and an UL transmission with the second satellite; (iv) the offset K_{mac} for delaying an application of a DL configuration indicated by a MAC CE command on a PDSCH from the second satellite; and (v) a configuration for an UL HARQ after the satellite switching.

In some implementations, a PCI of a cell serving communication apparatus 510 may be changed or unchanged after the satellite switching.

### Illustrative Processes

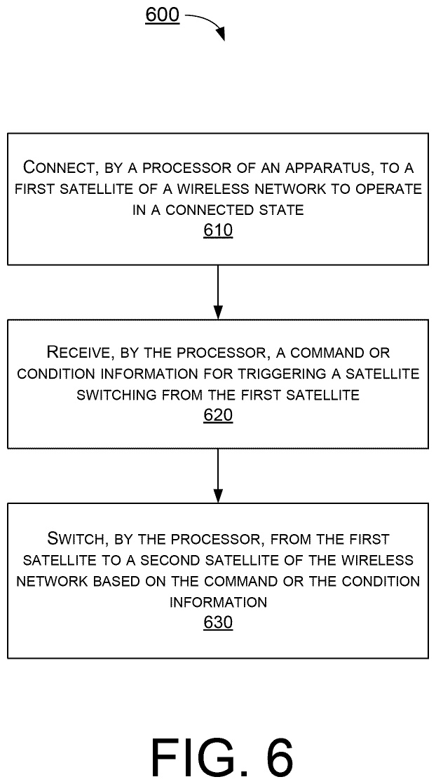

FIG. 6 illustrates an example process 600 in accordance with an implementation of the present disclosure. Process 600 may be an example implementation of above scenarios/schemes, whether partially or completely, with respect to satellite switching in mobile communications. Process 600 may represent an aspect of implementation of features of communication apparatus 510. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in communication apparatus 510 or any suitable UE or machine type devices. Solely for illustrative purposes and without limitation, process 600 is described below in the context of communication apparatus 510. Process 600 may begin at block 610.

At block 610, process 600 may involve processor 512 of communication apparatus 510 connecting, via transceiver 516, to a first satellite (e.g., network apparatus 510) of a wireless network to operate in a connected state (e.g., RRC_CONNECTED mode). Process 600 may proceed from block 610 to block 620.

At block 620, process 600 may involve processor 512 receiving, via transceiver 516, a command or condition information for triggering a satellite switching from the first satellite. Process 600 may proceed from block 620 to block 630.

At block 630, process 600 may involve processor 512 switching, via transceiver 516, from the first satellite to a second satellite of the wireless network based on the command or the condition information.

In some implementations, the command or the condition information may be received via an RRC signaling, a MAC CE, or a SIB.

In some implementations, the condition information may include at least one of the following: (i) first time information on when the first satellite is going to stop serving an area that the first satellite is currently covering, and second time information on when the second satellite is going to start serving the area; (ii) location information on where the apparatus is to be triggered for the satellite switching; and (iii) a value of a timer, wherein the switching from the first satellite to the second satellite is performed in an event that the timer expires.

In some implementations, the switching from the first satellite to the second satellite may be performed between a first time indicated by the first time information and a second time indicated by the second time information.

In some implementations, process 600 may further involve processor 512 receiving, via transceiver 516, a satellite switching configuration from the first satellite, wherein the switching from the first satellite to the second satellite is performed based on the satellite switching configuration.

In some implementations, the satellite switching configuration may be received via an RRC signaling, a MAC CE, or a SIB, and include a UE-specific configuration, a common configuration, or a group UE configuration.

In some implementations, the common configuration may include at least one of the following: (i) ephemeris information (e.g., neighbor satellite's SSV information consisting of PVT and orbital parameters) of the second satellite; (ii) common TA information of the second satellite, which indicates the TA between the second satellite and the RP; (iii) the scheduling offset K_{offset} for allowing the UE sufficient processing time between a DL reception and an UL transmission with the second satellite; (iv) the offset K_{mac} for delaying an application of a DL configuration indicated by a MAC CE command on a PDSCH from the second satellite; and (v) a configuration for an UL HARQ after the satellite switching.

In some implementations, a PCI of a cell serving communication apparatus 510 may be changed or unchanged after the satellite switching.

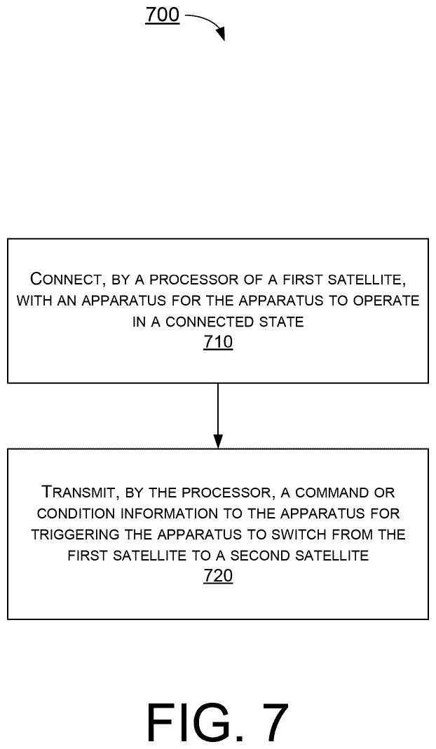

FIG. 7 illustrates an example process 700 in accordance with an implementation of the present disclosure. Process 700 may be an example implementation of above scenarios/schemes, whether partially or completely, with respect to satellite switching in mobile communications. Process 700 may represent an aspect of implementation of features of network apparatus 520. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by or in network apparatus 520 as well as any variations thereof. Solely for illustrative purposes and without limitation, process 700 is described below in the context of network apparatus 520. Process 700 may begin at block 710.

At block 710, process 700 may involve processor 522 of network apparatus 520 (e.g., a first satellite) connecting, via transceiver 526, with communication apparatus 510 for communication apparatus 510 to operate in a connected state (e.g., RRC_CONNECTED mode). Process 700 may proceed from block 710 to block 720.

At block 720, process 700 may involve processor 522 transmitting, via transceiver 526, a command or condition information to communication apparatus 510 for triggering communication apparatus 510 to switch from the first satellite to a second satellite.

In some implementations, the command or the condition information may be transmitted via an RRC signaling, a MAC CE, or a SIB.

In some implementations, the condition information may include at least one of the following: (i) first time information on when the first satellite is going to stop serving an area that the first satellite is currently covering, and second time information on when the second satellite is going to start serving the area; (ii) location information on where the apparatus is to be triggered for the satellite switching; and (iii) a value of a timer, wherein the switching from the first satellite to the second satellite is performed in an event that the timer expires.

In some implementations, the switching from the first satellite to the second satellite may be performed between a first time indicated by the first time information and a second time indicated by the second time information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
connecting, by a processor of an apparatus, to a first satellite of a wireless network to operate in a connected state;
receiving, by the processor, a command or condition information for triggering a satellite switching from the first satellite; and
switching, by the processor, from the first satellite to a second satellite of the wireless network based on the command or the condition information.

2. The method of claim 1, wherein the command or the condition information is received via a radio resource control (RRC) signaling, a medium access control (MAC) control element (CE), or a system information block (SIB).

3. The method of claim 1, wherein the condition information comprises at least one of the following:
first time information on when the first satellite is going to stop serving an area that the first satellite is currently covering, and second time information on when the second satellite is going to start serving the area;
location information on where the apparatus is to be triggered for the satellite switching; and
a value of a timer, wherein the switching from the first satellite to the second satellite is performed in an event that the timer expires.

4. The method of claim 3, wherein the switching from the first satellite to the second satellite is performed between a first time indicated by the first time information and a second time indicated by the second time information.

5. The method of claim 1, further comprising:
receiving, by the processor, a satellite switching configuration from the first satellite, wherein the switching from the first satellite to the second satellite is performed based on the satellite switching configuration.

6. The method of claim 5, wherein the satellite switching configuration is received via an RRC signaling, a MAC CE, or a SIB, and wherein the satellite switching configuration comprises a user equipment (UE)-specific configuration, a common configuration, or a group UE configuration.

7. The method of claim 6, wherein the common configuration comprises at least one of the following:
ephemeris information of the second satellite;
common timing advance (TA) information of the second satellite;
a scheduling offset for allowing the apparatus sufficient processing time between a downlink (DL) reception and an uplink (UL) transmission with the second satellite;
an offset for delaying an application of a DL configuration indicated by a MAC CE command on a physical downlink shared channel (PDSCH) from the second satellite; and
a configuration for an UL hybrid automatic repeat request (HARQ) after the satellite switching.

8. The method of claim 1, wherein a physical cell identifier (PCI) of a cell serving the apparatus is changed or unchanged after the satellite switching.

9. An apparatus, comprising:
a transceiver which, during operation, wirelessly communicates with a first satellite or a second satellite of a wireless network; and
a processor communicatively coupled to the transceiver such that, during operation, the processor performs operations comprising:
connecting, via the transceiver, to the first satellite to operate in a connected state;
receiving, via the transceiver, a command or condition information for triggering a satellite switching from the first satellite; and
switching, via the transceiver, from the first satellite to the second satellite based on the command or the condition information.

10. The apparatus of claim 9, wherein the command or the condition information is received via a radio resource control (RRC) signaling, a medium access control (MAC) control element (CE), or a system information block (SIB).

11. The apparatus of claim 9, wherein the condition information comprises at least one of the following:
first time information on when the first satellite is going to stop serving an area that the first satellite is currently covering, and second time information on when the second satellite is going to start serving the area;
location information on where the apparatus is to be triggered for the satellite switching; and
a value of a timer, wherein the switching from the first satellite to the second satellite is performed in an event that the timer expires.

12. The apparatus of claim 11, wherein the switching from the first satellite to the second satellite is performed between a first time indicated by the first time information and a second time indicated by the second time information.

13. The apparatus of claim 9, wherein, during operation, the processor further performs operations comprising:
receiving, via the transceiver, a satellite switching configuration from the first satellite, wherein the switching from the first satellite to the second satellite is performed based on the satellite switching configuration.

14. The apparatus of claim 13, wherein the satellite switching configuration is received via an RRC signaling, a MAC CE, or a SIB, and wherein the satellite switching configuration comprises a user equipment (UE)-specific configuration, a common configuration, or a group UE configuration.

15. The apparatus of claim 14, wherein the common configuration comprises at least one of the following:
ephemeris information of the second satellite;
common timing advance (TA) information of the second satellite;
a scheduling offset for allowing the apparatus sufficient processing time between a downlink (DL) reception and an uplink (UL) transmission with the second satellite;
an offset for delaying an application of a DL configuration indicated by a MAC CE command on a physical downlink shared channel (PDSCH) from the second satellite; and
a configuration for an UL hybrid automatic repeat request (HARQ) after the satellite switching.

16. The apparatus of claim 9, wherein a physical cell identifier (PCI) of a cell serving the apparatus is changed or unchanged after the satellite switching.

17. A method, comprising:
connecting, by a processor of a first satellite, with an apparatus for the apparatus to operate in a connected state; and
transmitting, by the processor, a command or condition information to the apparatus for triggering the apparatus to switch from the first satellite to a second satellite.

18. The method of claim 17, wherein the command or the condition information is transmitted via a radio resource control (RRC) signaling, a medium access control (MAC) control element (CE), or a system information block (SIB).

19. The method of claim 17, wherein the condition information comprises at least one of the following:
first time information on when the first satellite is going to stop serving an area that the first satellite is currently covering, and second time information on when the second satellite is going to start serving the area;
location information on where the apparatus is to be triggered for the satellite switching; and
a value of a timer, wherein the switching from the first satellite to the second satellite is performed in an event that the timer expires.

20. The method of claim 19, wherein the switching from the first satellite to the second satellite is performed between a first time indicated by the first time information and a second time indicated by the second time information.
